(19) United States
(12) Patent Application Publication
(10) Pub. No.: US 2022/0373121 A1
(43) Pub. Date: Nov. 24, 2022

(54) APPARATUS AND METHOD FOR CIRCULATING WATER USING CORRUGATED PIPE

(71) Applicant: Brian VON HERZEN, Minden, NV (US)

(72) Inventor: Brian VON HERZEN, Minden, NV (US)

(73) Assignee: The Climate Foundation, Seattle, WA (US)

(21) Appl. No.: 17/816,504

(22) Filed: Aug. 1, 2022

Related U.S. Application Data
(63) Continuation of application No. PCT/US21/16020, filed on Feb. 1, 2021.
(60) Provisional application No. 62/969,031, filed on Feb. 1, 2020.

(51) Int. Cl. F16L 47/02; B29C 65/00

(52) U.S. Cl. CPC F16L 47/02; B29C 66/71; B29C 66/5221; B29L 2023/18

(57) ABSTRACT

A method of welding/joining corrugated pipe segments, an apparatus configured to weld/join corrugated pipe segments, and a method of circulating water are disclosed. The method of welding/joining corrugated pipe segments includes holding or securing an end of each of the corrugated pipe segments with a jig, and welding the ends of the corrugated pipe segments together. The jig includes at least two rings, each configured to receive one of the ends of the corrugated pipe segments, and a brace or connector connected to each of the two rings. The apparatus includes the jig, a welding ring configured to receive the ends of the corrugated pipe segments, a resistive heating coil for heating the welding ring, and a control circuit configured to control a temperature of the resistive heating coil and maintain the temperature of the resistive heating coil once a target temperature is reached.

### CROSS REFERENCE TO RELATED APPLICATION

This application is a continuation of International Pat. Appl. No. PCT/US2021/16020, filed on Feb. 1, 2021, pending, which claims the benefit of U.S. Provisional Patent Application No. 62/969,031, filed on Feb. 1, 2020, both of which are incorporated herein by reference as if fully set forth herein.

### FIELD OF THE INVENTION

The present invention generally relates to the field of apparatuses for circulating (e.g., upwelling or downwelling) water, for example in a large, natural body of water, and methods of making and using such apparatuses.

### DISCUSSION OF THE BACKGROUND

Climate change is having a myriad of effects on the world's oceans, including mixed layer heating, marine stratification and deoxygenation. Two percent of all oxygen has already been lost from the Earth's oceans in recent decades. About 250 million years ago, the Permian Mass Extinction (also known as the Great Dying) was characterized by stratified, anoxic oceans. It is desirable to avoid a repeat of such an event.

Traditional approaches to upwelling and downwelling water in large, natural bodies of water have used straight-walled high-density polyethylene (HDPE) pipe. While effective, these pipes are costly, and must be made thick enough to withstand the pressure difference that commonly occurs between the interior and exterior of these pipes at appreciable depths in a large body of water without collapsing. The longer and/or wider the pipe, the thicker the wall thickness requirement.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

There is a need to increase the oxygen content locally in surface layers of oceans, lakes and other bodies of water, which can help keep life regionally in such bodies of water. Primary production in the ocean is responsible for most of the free oxygen we breathe. This primary production is dependent upon macronutrients available in deeper layers of the ocean. Such water can be transported from relatively deep water to shallower layers of water (e.g., upwelling). The present invention focuses on the use of corrugated pipe to upwell and downwell water in oceans, lakes and other bodies of water, natural and unnatural (e.g., reservoirs, basins, canals, etc.). Corrugated pipe generally achieves the same collapse resistance as straight-walled pipe, but using about an order of magnitude less material (e.g., 1 to 9.9 mm wall thicknesses, instead of 10 to 100 mm wall thicknesses common with straight HDPE pipe).

Thus, in one aspect, the present invention concerns a method of welding or joining two corrugated pipe segments, comprising holding or securing an end of each of the corrugated pipe segments with a jig, and welding the ends of the corrugated pipe segments together. The jig comprises (i) at least two rings configured to receive one of the ends of the corrugated pipe segments and (ii) a brace or connector connected to each of the two rings.

The corrugated pipe segments generally comprise a polymer (e.g., an organic polymer), such as acrylonitrile butadiene styrene (ABS), polyvinyl chloride (PVC), polybutylene (PB), polypropylene (PP), polyethylene (PE), and polyvinylidene fluoride (PVDF). In one embodiment, the polymer is high-density polyethylene (HDPE). The pipe and pipe segments are generally easy to remove from the body of water, and generally do not leave pollutants behind after a circulation project is completed.

In various embodiments of the method, welding the ends of the corrugated pipe segments together may comprise contacting the ends of the corrugated pipe segments and heating the ends of the corrugated pipe segments to at least the melting point or glass transition temperature of the polymer. For example, heating the ends of the corrugated pipe segments may comprise inserting the ends of the corrugated pipe segments into a resistive heating coil or ring, and resistively heating the ends of the corrugated pipe segments. In some cases, heating the ends of the corrugated pipe segments may further comprise setting a target temperature at which the ends of the corrugated pipe segments are heated, and controlling a current through the resistive heating coil or ring with a control circuit. In such cases, the method may further comprise (i) determining a resistance of the resistive heating coil or ring with the control circuit, (ii) correlating the resistance to a temperature of the resistive heating coil or ring, and/or (iii) adjusting a duty cycle of the resistive heating coil or ring with the control circuit when the resistive heating coil or ring reaches the target temperature.

In other or further embodiments of the method, each of the corrugated pipe segments has a length of about 6 to 350 meters (or any length or range of lengths therein) and/or a diameter of about 0.1 to 3.5 meters (or any diameter or range of diameters therein). Either or both of the corrugated pipe segments may be a “composite” or “compound” corrugated pipe segment, including 2 or more (e.g., 2-50, or any number or range of numbers therein) corrugated pipe segments that have already been previously welded together.

In another aspect, the present invention concerns an apparatus configured to weld or join two or more corrugated pipe segments, comprising a jig, a welding ring configured to receive the ends of the corrugated pipe segments, a resistive heating coil for heating the welding ring, and a control circuit configured to control a temperature of the resistive heating coil and maintain the temperature of the resistive heating coil once a target temperature is reached. The jig comprises (i) two rings, each configured to secure or hold an end of one of the corrugated pipe segments, and (ii) a brace or connector connected to each of the two rings.

As for the method of welding or joining two corrugated pipe segments, in the apparatus, the corrugated pipe segments comprise a polymer (e.g., an organic polymer), such as acrylonitrile butadiene styrene (ABS), polyvinyl chloride (PVC), polybutylene (PB), polypropylene (PP), polyethylene (PE), and polyvinylidene fluoride (PVDF), and the corrugated pipe segments may have a length of about 6 to 350 meters (or any length or range of lengths therein) and/or a diameter of about 0.1 to 3.5 meters (or any diameter or range of diameters therein). In one embodiment, the polymer is high-density polyethylene (HDPE).

In various embodiments, the control circuit may be configured to determine a resistance of the resistive heating coil, and the resistance may be correlated to a temperature of the resistive heating coil. Alternatively or additionally, the control circuit may be configured to adjust a duty cycle of the resistive heating coil.

In yet another aspect, the present invention concerns a method of circulating water, comprising inserting a segmented corrugated pipe into the water, securing the segmented corrugated pipe at different depths in the water, and allowing at least part of the water to flow from one of the ends of the segmented corrugated pipe to the other end of the segmented corrugated pipe. The segmented corrugated pipe comprises a plurality of corrugated pipe segments, and each of the corrugated pipe segments except terminal corrugated pipe segments have ends welded to an adjacent one of the corrugated pipe segments. In many applications of the method of circulating water, the water is a natural body of water having a depth of at least 100 meters, such as an ocean, a gulf, a bay, a lake, etc.

In some embodiments, allowing at least part of the water to flow from one end of the segmented corrugated pipe to the other end of the segmented corrugated pipe may comprise upwelling water from the lower end of the segmented corrugated pipe to the upper end of the segmented corrugated pipe. Alternatively, allowing at least part of the water to flow from one end of the segmented corrugated pipe to the other end of the segmented corrugated pipe may comprise downwelling water from the upper end of the segmented corrugated pipe to the lower end of the segmented corrugated pipe.

As for the method of welding or joining two corrugated pipe segments and the apparatus, in the method of circulating water, the corrugated pipe segments may comprise a polymer (e.g., an organic polymer), such as acrylonitrile butadiene styrene (ABS), polyvinyl chloride (PVC), polybutylene (PB), polypropylene (PP), polyethylene (PE), and polyvinylidene fluoride (PVDF). In one embodiment, the polymer is high-density polyethylene (HDPE).

In the method of circulating water, the segmented corrugated pipe may have a length of about 50 to about 500 meters (or any length or range of lengths therein), and each of the corrugated pipe segments may have a diameter of about 0.1 to 3.5 meters (or any diameter or range of diameters therein).

As described above, in some embodiments, the corrugated pipe comprises a plurality of segments, each having a length of about 6 to 350 meters, or any length or range of lengths therein (e.g., 6-100 meters, 7-30 meters, etc.). Upwelling distances are commonly 50 to 500 meters long. Thus, the corrugated pipe used in the present invention may include anywhere from 4 to about 100 segments, or any number or range of numbers therein (e.g., from 10 to 40 segments).

The present invention also includes novel approaches to welding or joining such pipe segments together. For example, the present invention includes an apparatus and a method for welding two segments of corrugated pipe using a welding ring.

The welding ring may have a resistive heating coil embedded within it or affixed to an inner or outer surface thereof. The resistive heating coil may have a temperature sensing capability and a control circuit to maintain a target temperature, once the target temperature is reached. The duty cycle of heating can also be adjusted in such a coil (e.g., with an appropriately configured control circuit). The resistance of the wire can indicate the temperature of the wire (e.g., the wire has a first resistance at ambient temperature [20-25° C.], and a second resistance at a welding temperature [150-250° C.]). By alternating heating and sensing, low-cost thermal regulation of corrugated pipe welding can be achieved with a single wire.

Alternatively, the welding can be done without a welding ring. Circularization rings can align the two pipe segments. The two pipe segments may be joined (i) at the maximum diameter to minimize fluid flow resistance, (ii) at the minimum diameter to maximize wall thickness, and/or (iii) on the slopes or curved surfaces to maximize surface bonding area.

These and other advantages of the present invention will become readily apparent from the detailed description of various embodiments below.

### BRIEF DESCRIPTION OF THE DRAWINGS

FIG. 1 is a conventional corrugated pipe segment.

FIG. 2 shows two corrugated pipe segments aligned with a jig.

FIG. 3 shows an exemplary apparatus including the pipe segments and jig of FIG. 2 in addition to a welding ring, a heating coil, a circuit, and a temperature controller.

FIGS. 4A-C show the welding point of two corrugated pipe segments at the narrowest point, a medial or “sloped” point, and the widest point, respectively.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

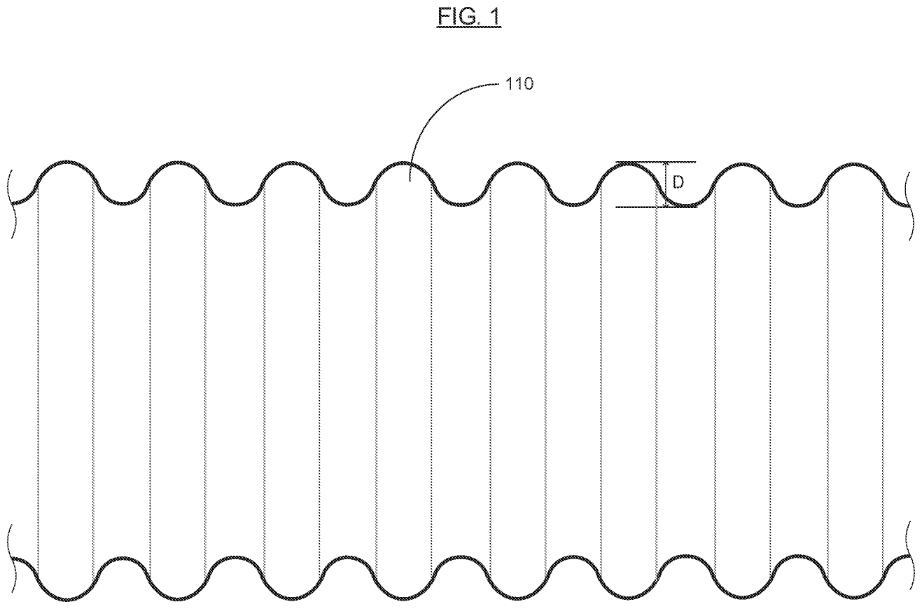

FIG. 1 shows a conventional corrugated pipe segment 110. The corrugated pipe segment 110 may comprise a polymer (e.g., an organic polymer) such as polyethylene (PE), acrylonitrile-butadiene-styrene (ABS), polyvinyl chloride (PVC), polybutylene (PB), polypropylene (PP), and/or polyvinylidene fluoride (PVDF). The polymer may become soft, pliable, moldable or liquid at an elevated temperature (e.g., may have a glass transition temperature of −125 to 100° C. and/or a melting point of 50-250° C.) and solidify upon cooling to ambient temperatures (e.g., about 25° C.). The polymer may have a weight average or number average molecular weight of 10,000-1,000,000 g/mol (or any value or range of values therein, such as 100-400 kg/mol). The polymer may be shaped and/or processed by various techniques such as injection molding, compression molding, calendering, and extrusion. If the polymer comprises polyethylene (PE), the PE may be low-density polyethylene (LDPE), medium-density polyethylene (MDPE), high-density polyethylene (HDPE), ultra-high molecular weight polyethylene (UHMWPE), polyethylene having raised temperature resistance (PE-RT), or cross-linked polyethylene (PEX). If the polymer comprises PVC, the PVC may be unplasticized PVC or post-chlorinated PVC (CPVC). In one preferred embodiment, the corrugated pipe segment comprises HDPE. The polymer must be capable of being welded (i.e., different pipe segments are weldable to each other) at a sufficiently high temperature (e.g., using a heating coil or other heat source). Typically, the polymer is welded at or above its melting point or glass transition temperature (e.g., 120-250° C., or any temperature or range of temperatures therein that are at or above the melting point or glass transition temperature of the polymer).

The corrugated pipe segment 100 generally achieves the same collapse resistance as an otherwise identical straight-walled pipe segment having about an order-of-magnitude greater wall thickness. Thus, for example, the corrugated pipe segment 100 may have a wall thickness of 1 to 9.9 mm (as compared to a 10-to-100 mm wall thickness for straight HDPE pipe). Consequently, the present invention uses significantly less material than the background method.

The corrugated pipe segment 110 may have a length of about 6 to about 350 meters (e.g., from 7 meters to 1000 feet [305 meters]) and a diameter of about 0.1 to 3.5 meters (e.g., 0.5 meters, or any diameter or range of diameters therein). A completed corrugated pipe may comprise a plurality of pipe segments 100, each having a length of about 6 to 305 meters. Upwelling distances are commonly 50 to 500 meters long or more. Thus, the completed corrugated pipe used in the present invention may include anywhere from 2 to about 100 segments (e.g., from 10 to 40 segments).

The corrugated pipe segment 110 may consist of a continuous series of corrugations, having alternating peaks/crests and troughs/valleys. Examples of the corrugated pipe segment 110 may have a peak-to-peak or trough-to-trough distance of 2-30 cm and a peak-to-trough distance D of 1-15 cm.

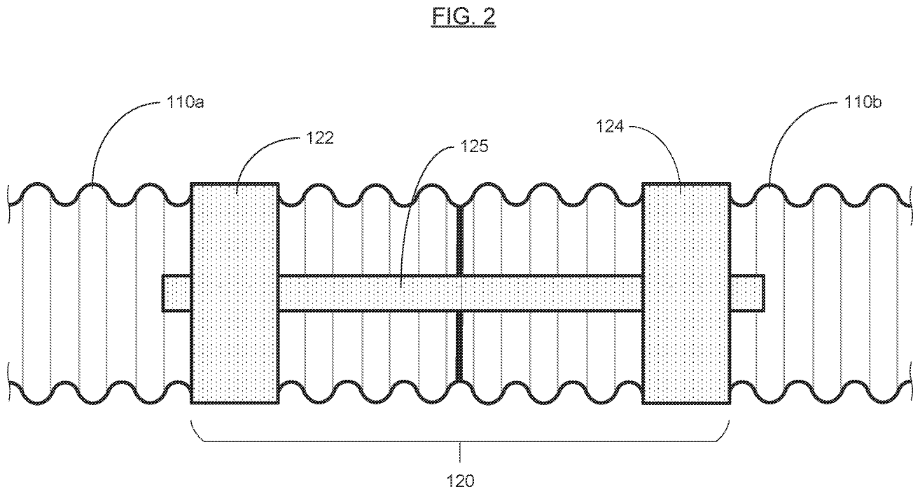

FIG. 2 shows two corrugated pipe segments 110a-b aligned with a jig 120. The jig 120 is configured to support the two corrugated pipe segments 110a-b while the segments 110a-b are being welded together. The jig may comprise two rings 122 and 124 and a connector or brace 125. Each of the rings 122 and 124 may have a diameter greater than the pipe segments 110a-b. In some embodiments, the diameter of each of the rings 122 and 124 is adjustable, and thus, may accommodate pipe segments 110a-b having varying diameters (e.g., ½ meter, 1 meter, etc.). For example, each of the rings 122 and 124 may comprise or consist of a flip-lever clamp, a screw or worm gear clamp, etc. Each of the rings 122 and 124 may also have a depth or width of 2.5-15 cm and a wall thickness of 1-10 mm. The jig 120 may include more than one connector or brace 125, in which case the connectors or braces 125 may be equally spaced apart (i.e., separated by 360°/n or 2π/n radians, in which n is the number of connectors or braces 125). The connector or brace 125 may have a length of 10-100 cm, a width of 2-10 cm, and a thickness of 1-10 mm. The jig 120 may comprise a metal such as steel or aluminum.

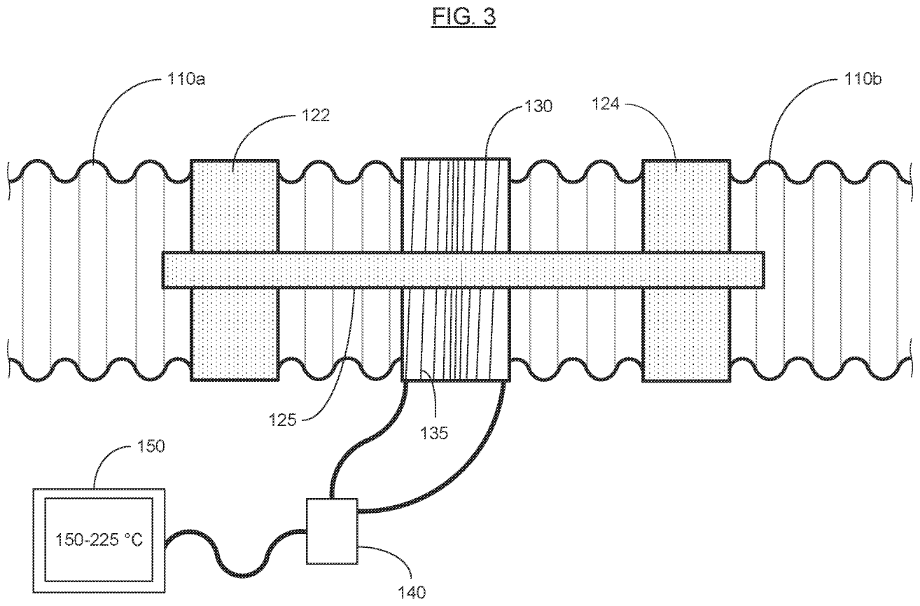

FIG. 3 shows the two corrugated pipe segments 110a-b, the jig 120 comprising the rings 122-124 and the connector 125, a welding ring 130, a resistive heating coil 135, a control circuit 140, and an optional display 150.

The welding ring 130 is configured to weld or join two or more corrugated pipe segments 110a-b. The resistive heating coil 135 is configured to raise the temperature of the polymer evenly at an interface between the two corrugated pipe segments 110a-b (e.g., using Joule heating or ohmic heating). The resistive heating coil 135 may be embedded within the welding ring 130, or when the welding ring 130 comprises or consists of a metal cylinder, the resistive heating coil 135 may be on an inner or outer surface of the metal cylinder. For example, the heating coil 135 may comprise a metal or alloy such as aluminum, steel (e.g., stainless steel), a NiCr alloy, an FeCrAl alloy, or CuNi alloy, or a ceramic material such as MoSi₂ or silicon carbide, etc. The welding ring 130 may have an outer diameter greater than the pipe segments 110a-b, but may have an inner surface that, in at least one section of the ring, is configured to contact the ends of each corrugated pipe segment 110a-b and thus apply heat directly to the ends of the corrugated pipe segments 110a-b at the interface therebetween and weld the corrugated pipe segments 110a-b together. In a further embodiment, the welding ring 130 has an undulating inner surface configured to match the outer surface of the corrugated pipe segments 110a-b.

In some embodiments, the diameter of each of the welding ring 130 is adjustable, and thus may accommodate pipe segments 110a-b having varying diameters (e.g., ½ meter, 1 meter, etc.). In such cases, one or more sections of the heating coil 135 is not embedded in or affixed to the surface of the welding ring 130, but is still embedded in or coated with a (flexible) thermal insulator such as a high temperature-resistant polymer to accommodate changes in the diameter of the welding ring 130. As shown in FIG. 3, the heating coil 135 may have a higher density of loops in the center of the welding ring 130, where the ends of the corrugated pipe segments 110a-b are welded together and the greatest amount of heat is needed. However, the heating coil 135 may be evenly distributed along the length or height of the welding ring cylinder 130.

During welding, the heating coil 135 may be raised to a temperature of from 120 to 250° C., or any temperature or range of temperatures therein (e.g., from 120 to 180° C., a typical melting point or glass transition temperature range for HDPE). The control circuit 140 is connected to the resistive heating coil 135. The control circuit 140 may have a temperature sensing capability (e.g., in which the control circuit 140 determines the resistance of the coil 135; the control circuit or other processor correlates the resistance to the temperature of the coil 135), and is configured to maintain a target temperature once the target temperature is reached (e.g., 180° C.). For example, the target temperature may be maintained for a length of time of from 10 minutes to 3-4 hours, or any length of time that may be practical for thermal cycling (e.g., temperature ramp-up from ambient temperature to target temperature, target temperature maintenance, and cool down from target temperature to ambient or near ambient temperature). The display 150 may be configured to show the current temperature of the coil 135 and provide a user with an interface through which the temperature of the coil 135 may be increased and decreased, and optionally, the rate at which the temperature is changed. The display 150 may also be used to adjust the duty cycle of heating in the control circuit 140. In some embodiments, the display 150 may be a smartphone or a computer, and may communicate with the control circuit 140 through a wire or wirelessly (e.g., using the Bluetooth® protocol). By alternating heating and sensing, low-cost thermal regulation of corrugated pipe welding can be achieved with the single resistive heating coil 135.

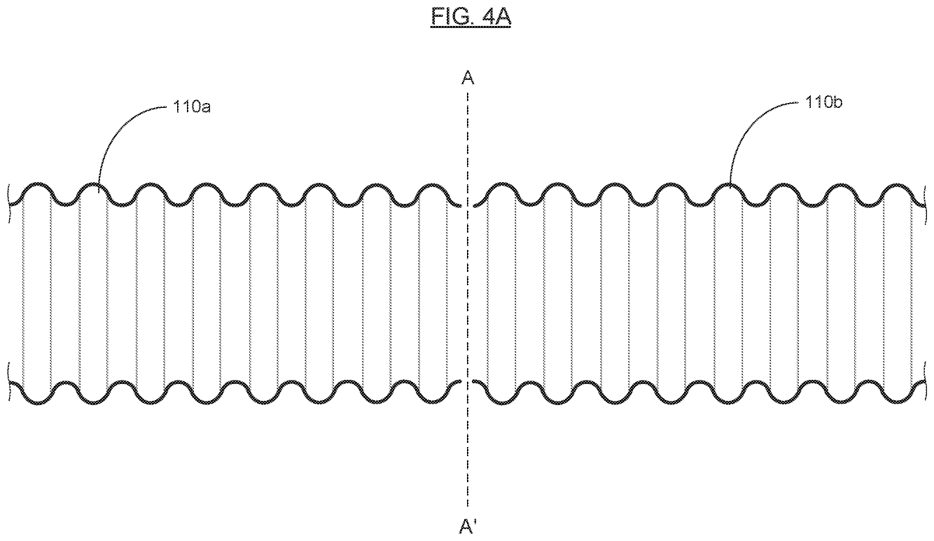

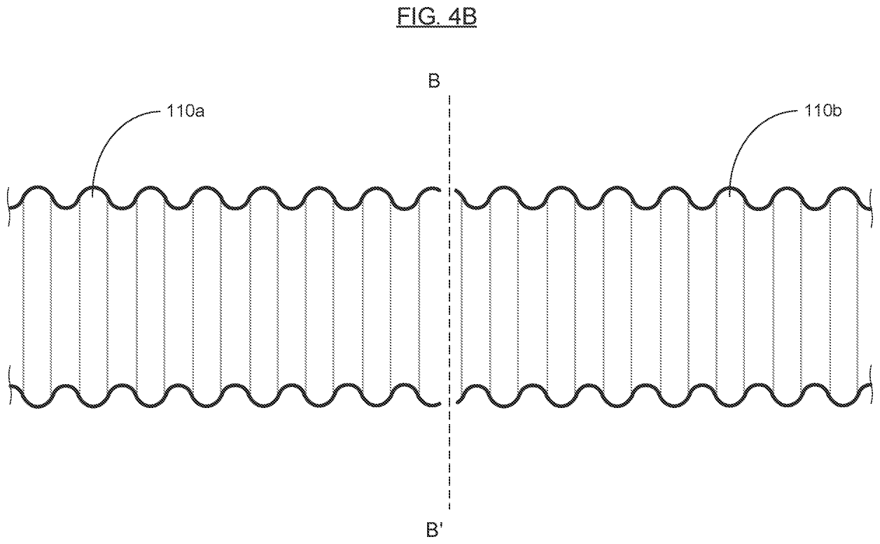

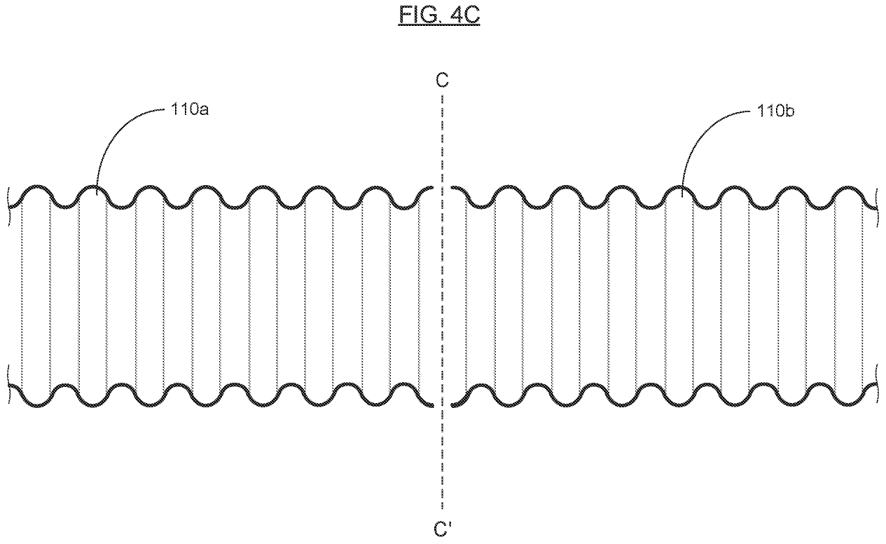

FIGS. 4A-C show various welding points of the two corrugated pipe segments 110a-b. The corrugated pipe segments 110a-b may be welded at the narrowest point (e.g., trough-to-trough; see FIG. 4A), a medial or “sloped” point (e.g., “slope-to-slope”; see FIG. 4B), and the widest point (e.g., crest-to-crest; see FIG. 4C). Typically, the weld will cause a slight increase in the thickness of the pipe at the welding point (i.e., the interface between adjacent pipe segments 110a-b), but may also cause some minor thinning in locations adjacent to the weld.

The different locations of the welding points offer different advantages. Welding at the narrowest point (the dashed line A-A′ in FIG. 4A) maximizes the thickness of the walls of the segments 110a-b, and may effectively apply pressure from the water external to the pipe to the weld during use. Welding at a medial or “sloped” point (the dashed line B-B′ in FIG. 4B) maximizes the surface bonding area during welding. Welding at the widest point (the dashed line C-C′ in FIG. 4C) minimizes fluid flow resistance during upwelling/downwelling. It may be advantageous to weld at the narrow or medial points (FIGS. 4A-B) when constructing a pipe to be used in deeper water (to withstand the higher pressures at extreme depths), and to weld at the widest point (FIG. 4C) when constructing a pipe for maximum fluid flow.

Use of the corrugated pipe (i.e., the plurality of welded pipe segments) is substantially or exactly according to the conventional use. For example, as described herein, the corrugated pipe is used to circulate (e.g., upwell or downwell) water in a large, preferably natural body of water. Such as a lake, bay, gulf or ocean. Water may be therefore circulated by inserting the present segmented corrugated pipe into the water, securing the segmented corrugated pipe at different depths in the water (e.g., such that one end of the pipe is at a first depth in the water, and the other end of the pipe is at a second, significantly greater depth in the water), and allowing at least part of the water to flow from one end of the segmented corrugated pipe to the other end. For example, the first depth may be from 1 to 20 meters or more below the surface of the water, and the second depth may be 50 to 500 meters (or more) greater than the first depth.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method of welding or joining two corrugated pipe segments, comprising:
holding or securing an end of each of the corrugated pipe segments with a jig, the jig comprising (i) at least two rings configured to receive one of the ends of the corrugated pipe segments and (ii) a brace or connector connected to each of the two rings; and
welding the ends of the corrugated pipe segments together.

2. The method of claim 1, wherein the corrugated pipe segments comprise a polymer.

3. The method of claim 2, wherein the polymer is selected from acrylonitrile butadiene styrene (ABS), polyvinyl chloride (PVC), polybutylene (PB), polypropylene (PP), polyethylene (PE), and polyvinylidene fluoride (PVDF).

4. The method of claim 2, wherein welding the ends of the corrugated pipe segments together comprises contacting the ends of the corrugated pipe segments and heating the ends of the corrugated pipe segments to at least the melting point or glass transition temperature of the polymer.

5. The method of claim 1, wherein each of the corrugated pipe segments has a length of about 6 to 350 meters.

6. The method of claim 1, wherein each of the corrugated pipe segments has a diameter of about 0.1 to 3.5 meters.

7. An apparatus configured to weld or join two or more corrugated pipe segments, comprising:
a jig, comprising (i) two rings, each configured to secure or hold an end of one of the corrugated pipe segments, and (ii) a brace or connector connected to each of the two rings;
a welding ring configured to receive the ends of the corrugated pipe segments;
a resistive heating coil for heating the welding ring; and
a control circuit configured to control a temperature of the resistive heating coil and maintain the temperature of the resistive heating coil once a target temperature is reached.

8. The apparatus of claim 7, wherein the corrugated pipe segments comprise a polymer.

9. The apparatus of claim 7, wherein the control circuit is configured to determine a resistance of the resistive heating coil, and the resistance is correlated to a temperature of the resistive heating coil.

10. The apparatus of claim 7, wherein the control circuit is configured to adjust a duty cycle of the resistive heating coil.

11. The apparatus of claim 7, wherein the corrugated pipe segments have a length of about 6 to 350 meters.

12. The apparatus of claim 7, wherein the corrugated pipe segments have a diameter of about 0.1 to 3.5 meters.

13. A method of circulating water, comprising:
inserting a segmented corrugated pipe into the water, the segmented corrugated pipe comprising a plurality of corrugated pipe segments, each of the corrugated pipe segments except terminal ones of the corrugated pipe segments having ends welded to an adjacent one of the corrugated pipe segments;
securing the segmented corrugated pipe at different locations in the water; and
allowing at least part of the water to flow from one of the ends of the segmented corrugated pipe to the other end of the segmented corrugated pipe.

14. The method of claim 13, wherein allowing at least part of the water to flow from the one end of the segmented corrugated pipe to the other end of the segmented corrugated pipe comprises upwelling the at least part of the water from the lower end of the segmented corrugated pipe to the upper end of the segmented corrugated pipe.

15. The method of claim 13, wherein allowing at least part of the water to flow from the one end of the segmented corrugated pipe to the other end of the segmented corrugated pipe comprises downwelling the at least part of the water from the upper end of the segmented corrugated pipe to the lower end of the segmented corrugated pipe.

16. The method of claim 13, wherein the corrugated pipe segments comprise a polymer.

17. The method of claim 16, wherein the polymer is selected from acrylonitrile butadiene styrene (ABS), polyvinyl chloride (PVC), polybutylene (PB), polypropylene (PP), polyethylene (PE), and polyvinylidene fluoride (PVDF).

18. The method of claim 13, wherein the segmented corrugated pipe has a length of about 50 to about 500 meters.

19. The method of claim 13, wherein each of the corrugated pipe segments has a diameter of about 0.1 to 3.5 meters.

20. The method of claim 13, wherein the water is a natural body of water having a depth of at least 100 meters.
